(19) United States
(12) Patent Application Publication
(10) Pub. No.: US 2024/0326925 A1
(43) Pub. Date: Oct. 3, 2024

(54) VEHICLE BOTTOM STRUCTURE

(71) Applicant: Honda Motor Co., Ltd., Tokyo (JP)

(72) Inventors: Hirotaka HAYAKAWA, Tokyo (JP); Shinichi KAJI, Tokyo (JP); Reo Ohi, Saitama (JP)

(73) Assignee: Honda Motor Co., Ltd., Tokyo (JP)

(21) Appl. No.: 18/586,512

(22) Filed: Feb. 25, 2024

(30) Foreign Application Priority Data
Mar. 28, 2023 (CN) 202310312719.8

(51) Int. Cl. B62D 25/20; B62D 21/02; B62D 21/11; B62D 25/16

(52) U.S. Cl. CPC B62D 25/20; B62D 21/02; B62D 21/11; B62D 25/16

(57) ABSTRACT

A vehicle bottom structure includes: a back floor bottom panel, including a protrusion portion; and a pair of wheel houses, disposed on outer sides of the back floor bottom panel in a vehicle width direction. The protrusion portion is disposed on a central side between the pair of wheel houses in the vehicle width direction and protrudes upward in a vehicle up-down direction. The protrusion portion includes a longitudinal wall, and the longitudinal wall is formed at a front end of the protrusion portion in a vehicle front-back direction. The longitudinal wall and the pair of wheel houses are disposed in parallel in the vehicle width direction.

### CROSS-REFERENCE TO RELATED APPLICATION

This application claims the priority benefit of China application serial no. 202310312719.8, filed on Mar. 28, 2023. The entirety of the above-mentioned patent application is hereby incorporated by reference herein and made a part of this specification.

### BACKGROUND

### Technical Field

The disclosure relates to a vehicle bottom structure.

### Description of Related Art

In order to allow vulnerable groups such as the elderly, the disabled, children and the like to use a sustainable transportation system, commitments have been made to provide transportation vehicles with better vehicle body rigidity. In the existing technology, convex strips are disposed in the vehicle bottom structure to support the rear seats. However, when the back floor bottom panel needs to carry a load when turning or encountering uneven roads, it is difficult to fully support with the convex strips alone. In addition, with the development of electric vehicles, there is a need to carry large batteries. As the weight of the vehicle increases, the requirements for rigidity also increase. In order to solve the above-mentioned problems, the disclosure aims to improve the rigidity of the floor bottom panel. Furthermore, the rigidity of the vehicle body is further improved and contributes to the development of a sustainable conveyor system.

### SUMMARY

The disclosure provides a vehicle bottom structure that has better rigidity to suppress torsion of the floor bottom panel and improve operability.

A vehicle bottom structure of the disclosure includes: a back floor bottom panel, including a protrusion portion; and a pair of wheel houses, disposed on an outer side of the back floor bottom panel in a vehicle width direction. The protrusion portion is disposed on a central side between the pair of wheel houses in the vehicle width direction and protrudes upward in a vehicle up-down direction. The protrusion portion includes a longitudinal wall, and the longitudinal wall is formed at a front end of the protrusion portion in a vehicle front-back direction. The longitudinal wall and the pair of wheel houses are disposed in parallel in the vehicle width direction.

Based on the above, in the vehicle bottom structure of the disclosure, the protrusion portion includes the longitudinal wall disposed in parallel to the pair of wheel houses in the vehicle width direction. Therefore, the load from the wheel house can be transmitted to the longitudinal wall and distributed, thereby improving the rigidity of the back floor bottom panel. Accordingly, the vehicle bottom structure of the disclosure has better rigidity to suppress torsion of the floor bottom panel and improve operability.

In order to make the above-mentioned features and advantages of the disclosure clearer and easier to understand, the following embodiments are given and described in details with accompanying drawings as follows.

### BRIEF DESCRIPTION OF THE DRAWINGS

FIG. 1 is a schematic three-dimensional view of a vehicle bottom structure according to an embodiment of the disclosure.

FIG. 2 is a partial top view of the vehicle bottom structure of FIG. 1.

FIG. 3 is a partial bottom view of the vehicle bottom structure of FIG. 1.

FIG. 4A and FIG. 4B are cross-sectional views of the vehicle bottom structure of FIG. 2 along section lines A-A and B-B.

### DESCRIPTION OF THE EMBODIMENTS

In an embodiment of the disclosure, the back floor bottom panel further includes: side frames, disposed on an outer side in the vehicle width direction, and extending along the vehicle front-back direction; and a pair of longitudinal bones, extending along the vehicle front-back direction and away from the side frames in the vehicle width direction. From a viewing angle in the vehicle up-down direction, part of the pair of longitudinal bones overlap the longitudinal walls.

In an embodiment of the disclosure, the back floor bottom panel further includes a floor cross member. The floor cross member is connected to the pair of wheel houses. The longitudinal wall is disposed further forward than the floor cross member in the vehicle front-back direction, and the floor cross member intersects the pair of longitudinal bones.

In an embodiment of the disclosure, the protrusion portion further includes an upper wall. The upper wall extends from an upper end of the longitudinal wall in the vehicle up-down direction toward the back in the vehicle front-back direction, and the upper wall intersects the floor cross member.

In an embodiment of the disclosure, the pair of longitudinal bones are disposed on a lower surface of the back floor bottom panel. From a viewing angle in the vehicle front-back direction, a cross section of each of the pair of longitudinal bones is formed into a hat shape with an opening facing upward in the vehicle up-down direction. The back floor bottom panel also includes a patch component. From a viewing angle in the vehicle up-down direction, the patch component overlaps the longitudinal wall, and the patch component is connected to the pair of longitudinal bones.

In an embodiment of the disclosure, the patch component includes an extension portion. The extension portion extends toward the back in the vehicle front-back direction and intersects the floor cross member.

In an embodiment of the disclosure, the floor cross member includes a reinforcement member. The reinforcement member extends toward the back in the vehicle front-back direction and is joined to the back floor bottom panel. The reinforcement member is disposed on an upper surface of the back floor bottom panel. From a viewing angle in the vehicle up-down direction, the reinforcement member overlaps the extension portion of the patch component.

In an embodiment of the disclosure, the back floor bottom panel is disposed with a driving source below in the vehicle up-down direction. From a viewing angle in the vehicle up-down direction, the pair of longitudinal bones overlap the driving source.

In an embodiment of the disclosure, the vehicle bottom structure further includes: a step portion, disposed in front of the longitudinal wall in the vehicle front-back direction, and connecting a front floor bottom panel and the back floor bottom panel. An intermediate step portion is disposed between the step portion and the longitudinal wall.

In an embodiment of the disclosure, the pair of wheel houses include shock-absorbing support portions. The shock-absorbing support portions are disposed at upper ends of the pair of wheel houses in the vehicle up-down direction. The longitudinal wall is disposed further forward than the shock-absorbing support portions in the vehicle front-back direction.

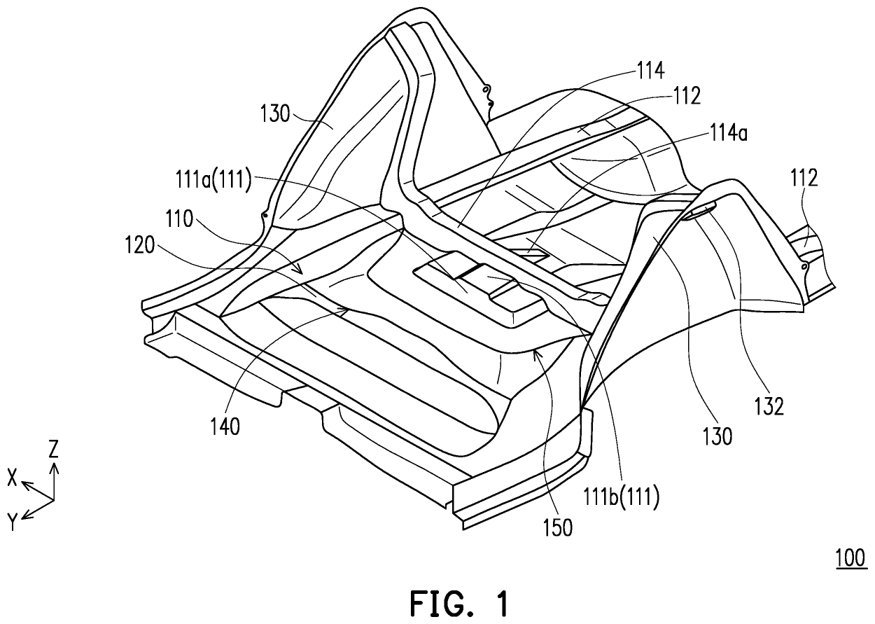

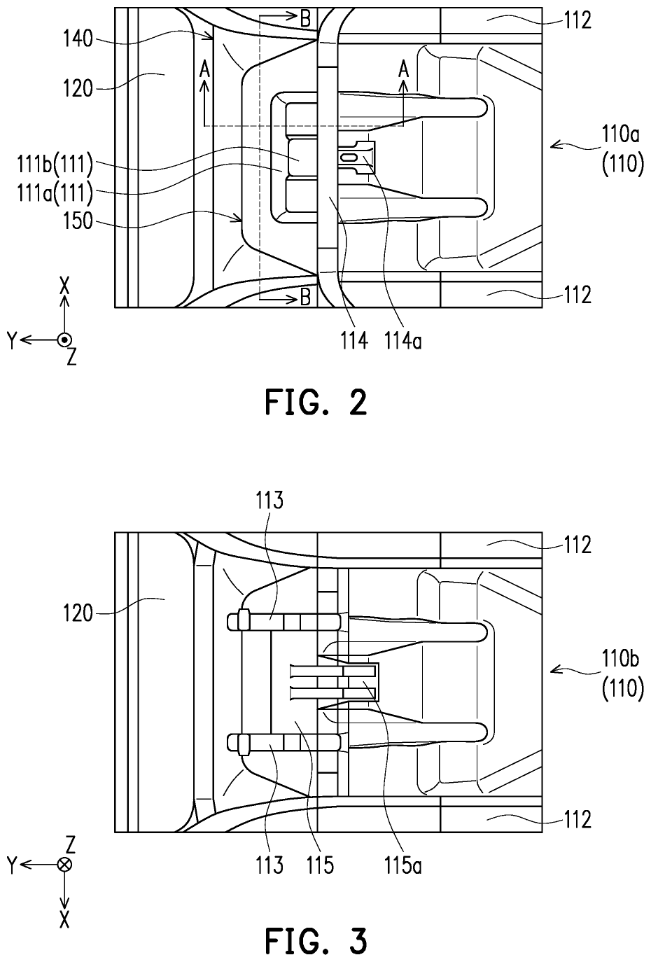

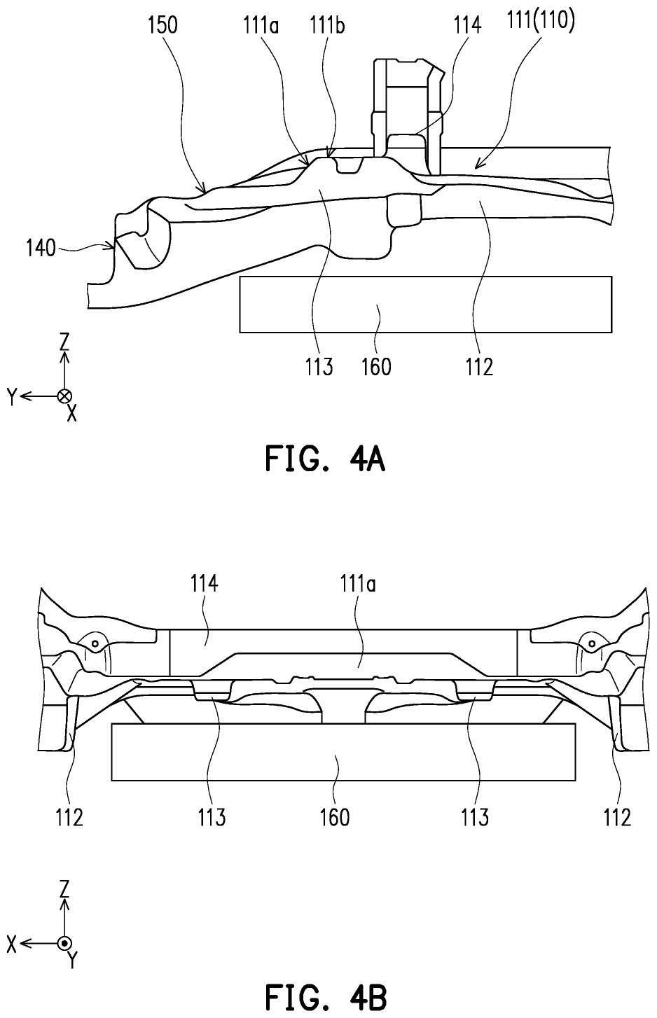

FIG. 1 is a schematic three-dimensional view of a vehicle bottom structure according to an embodiment of the disclosure. FIG. 2 is a partial top view of the vehicle bottom structure of FIG. 1. FIG. 3 is a partial bottom view of the vehicle bottom structure of FIG. 1. FIG. 4A and FIG. 4B are cross-sectional views of the vehicle bottom structure of FIG. 2 along section lines A-A and B-B. In the embodiment, a vehicle bottom structure 100 is, for example, a bottom structure used in an ordinary passenger car (not shown), especially the area structure near the rear seat (not shown) in the vehicle body, but may also be applied to other devices with similar structures, and the disclosure is not limited thereto. A vehicle width direction X, a vehicle front-back direction Y, and a vehicle up-down direction Z in the drawings are not intended to limit the positional relationship of each component in the disclosure. In addition, it should be noted that, unless otherwise specified, the front and up used herein are the directions pointed by the vehicle front-back direction Y and the vehicle up-down direction Z arrows, and the back and down used herein are the opposite directions mentioned above; the inner side and outer side used herein are relative positions in the vehicle width direction X. The direction pointed by the vehicle width direction X arrow is not used to limit the inner side or the outer side. Whenever possible, the same reference numbers are used in the drawings and description to refer to the same or similar parts. The vehicle bottom structure 100 of the embodiment will be described below with reference to FIG. 1 to FIG. 4B.

Please refer to FIG. 1. In the embodiment, the vehicle bottom structure 100 includes a back floor bottom panel 110, a front floor bottom panel 120, and a pair of wheel houses 130. The back floor bottom panel 110 is connected to the back of the front floor bottom panel 120 in the vehicle front-back direction Y. The pair of wheel houses 130 are disposed on the outer side of the back floor bottom panel 110 in the vehicle width direction X and are connected to the top of the back floor bottom panel 110 in the vehicle up-down direction Z. The back floor bottom panel 110 includes a protrusion portion 111. The protrusion portion 111 is disposed on the central side between the pair of wheel houses 130 in the vehicle width direction X and protrudes upward in the vehicle up-down direction Z. Specifically, from the viewing angle in the vehicle width direction X (i.e., the viewing angle of FIG. 4A), the cross section of the protrusion portion 111 is formed into an arch shape, but the disclosure is not limited thereto. In addition, the protrusion portion 111 includes a longitudinal wall 111a. The longitudinal wall 111a is formed at the front end of the protrusion portion 111 in the vehicle front-back direction Y. Furthermore, the longitudinal wall 111a and the pair of wheel houses 130 are disposed in parallel in the vehicle width direction X. Specifically, the long side direction of the longitudinal wall 111a extends along the vehicle width direction X, and the short side direction extends along the back in the vehicle front-back direction Y and upward in the vehicle up-down direction Z, that is, forming into an inclined wall. However, the disclosure is not limited thereto, as long as the extending direction of the long side direction corresponds to the wheel house 130.

As can be seen from this, in the vehicle bottom structure 100 of the present embodiment, the protrusion portion 111 includes the longitudinal wall 111a disposed in parallel to the pair of wheel houses 130 in the vehicle width direction X. Therefore, the load from the wheel house 130 can be transmitted to the longitudinal wall 111a and distributed, thereby improving the rigidity of the back floor bottom panel 110. Accordingly, the vehicle bottom structure 100 of the embodiment has better rigidity to suppress torsion of the floor bottom panel and improve operability.

Please refer to FIG. 2 to FIG. 4A. In the embodiment, the back floor bottom panel 110 also includes side frames 112, a pair of longitudinal bones 113 (as shown in FIG. 3), and a floor cross member 114. The side frames 112 are disposed on the outer side in the vehicle width direction X and extends along the vehicle front-back direction Y. The pair of wheel houses 130 are disposed on the side frames 112, but the disclosure is not limited thereto. As shown in FIG. 3, the pair of longitudinal bones 113 extend along the vehicle front-back direction Y and are away from the side frames 112 in the vehicle width direction X. Specifically, the pair of longitudinal bones 113 are disposed on a lower surface 110b of the back floor bottom panel 110 and are away from the inside of the side frames 112 in the vehicle width direction X. However, in other embodiments not shown, the pair of longitudinal bones 113 may also be disposed on an upper surface 110a of the back floor bottom panel 110, and the disclosure is not limited thereto. From a viewing angle in the vehicle up-down direction Z (please refer to FIG. 2 and FIG. 3), part of the pair of longitudinal bones 113 overlap the longitudinal wall 111a. The floor cross member 114 extends along the vehicle width direction X and is connected to the pair of wheel houses 130. The longitudinal wall 111a is disposed further forward than the floor cross member 114 in the vehicle front-back direction Y, and the floor cross member 114 intersects the back ends of the pair of longitudinal bones 113 in the vehicle front-back direction Y. Therefore, the load transmitted from the wheel house 130 can be sequentially transmitted from the longitudinal wall 111a to the longitudinal bone 113 and then to the floor cross member 114, so as to effectively distribute the load everywhere, thereby improving the rigidity of the back floor bottom panel 110. Accordingly, it can suppress torsion of the back floor bottom panel 110 caused by the vehicle body turning or encountering uneven road surfaces.

Furthermore, in the embodiment, the protrusion portion 111 further includes an upper wall 111b. The upper wall 111b extends from the upper end of the longitudinal wall 111a in the vehicle up-down direction Z toward the back in the vehicle front-back direction Y, and the upper wall 111b intersects the floor cross member 114. In this way, the inclination angle of the longitudinal wall 111a to the back in the vehicle front-back direction Y can be relaxed, thereby improving the surface rigidity of the back of the back floor bottom panel 110.

Please refer to FIG. 2 to FIG. 4B. In the embodiment, from the viewing angle in the vehicle front-back direction Y (i.e., the viewing angle of FIG. 4B), the cross-section of each of the pair of longitudinal bones 113 is formed into a hat shape with an opening facing upward in the vehicle up-down direction Z. As shown in FIG. 3, the back floor bottom panel 110 also includes a patch component 115. The patch component 115 is disposed on the lower surface 110b of the back floor bottom panel 110, and from a viewing angle in the vehicle up-down direction Z (please refer to FIG. 2 and FIG. 3), the patch component 115 overlaps the longitudinal wall 111a. The patch component 115 is connected to the pair of longitudinal bones 113 in the vehicle width direction X. With such a configuration, the load can be transmitted from the longitudinal bones 113 to the patch component 115, thereby effectively distributing the load. In addition, disposing the patch component 115 corresponding to the longitudinal wall 111a in the vehicle up-down direction Z can increase the thickness of such an area so as to further improve the rigidity. In addition, the patch component 115 includes an extension portion 115a. The extension portion 115a extends toward the back in the vehicle front-back direction Y and intersects the floor cross member 114. Accordingly, the load transmitted to the patch component 115 can also be transmitted to the floor cross member 114, thereby effectively distributing the load.

In addition, in the embodiment, the floor cross member 114 includes a reinforcement member 114a. The reinforcement member 114a extends toward the back in the vehicle front-back direction Y and is joined to the back floor bottom panel 110. The joining method is, for example, screw locking, but the disclosure is not limited thereto, and other suitable joining methods may also be used. The reinforcement member 114a is disposed on the upper surface 110a of the back floor bottom panel 110, and from the viewing angle in the vehicle up-down direction Z, the reinforcement member 114a overlaps the extension portion 115a of the patch component 115. In this way, the load transmitted to the patch component 115 can also be transmitted to the floor cross member 114 more effectively, thereby distributing the load to improve the rigidity of the back floor bottom panel 110.

Please return to FIG. 1. In the embodiment, the pair of wheel houses 130 include shock-absorbing support portions 132. The shock-absorbing support portions 132 are disposed at the upper ends of the pair of wheel houses 130 in the vehicle up-down direction Z. Preferably, the longitudinal wall 111a is disposed further forward than the shock-absorbing support portions 132 in the vehicle front-back direction Y. Since the cause of vehicle body torsion is the relative positional shift of the front tires and back tires, torsion is particularly likely to occur in the floor bottom panel between the front wheel house and the back wheel house. If the longitudinal wall 111a is disposed close to the shock-absorbing support portions 132 and between the front wheel house and the back wheel house, torsion can be suppressed more effectively.

In addition, in the embodiment, the vehicle bottom structure 100 further includes a step portion 140. The step portion 140 is disposed in front of the longitudinal wall 111a in the vehicle front-back direction Y and connects the front floor bottom panel 120 and the back floor bottom panel 110. An intermediate step portion 150 is disposed between the step portion 140 and the longitudinal wall 111a. Specifically, the intermediate step portion 150 is disposed above the pair of longitudinal bones 113 in the vehicle up-down direction Z, and the intermediate step portion 150 is connected to the pair of longitudinal bones 113. Accordingly, the load can be reliably transmitted to the longitudinal bone 113 and the load can be efficiently distributed.

Please refer to FIG. 4A and FIG. 4B. In the embodiment, the back floor bottom panel 110 is disposed with a driving source 160 below in the vehicle up-down direction Z. From the viewing angle in the vehicle up-down direction Z, the pair of longitudinal bones 113 overlap the driving source 160. In other words, the pair of longitudinal bones 113 are disposed above the driving source 160 in the vehicle up-down direction Z, thereby providing strong support rigidity to protect the driving source 160. In addition, if there are foreign objects falling downward from the inside of the car, the longitudinal bones 113 can also block them first. Furthermore, disposing the longitudinal bones 113 can reduce the thickness of the back floor bottom panel 110 in the vehicle up-down direction Z, thereby providing more space for the driving source 160 to increase capacity.

In summary, in the vehicle bottom structure of the disclosure, the protrusion portion includes the longitudinal wall disposed in parallel to the pair of wheel houses in the vehicle width direction. Therefore, the load from the wheel house can be transmitted to the longitudinal wall and distributed, thereby improving the rigidity of the back floor bottom panel. In addition, the back floor bottom panel also includes the pair of longitudinal bones and the floor cross member. Part of the longitudinal bone overlaps the longitudinal wall, and the floor cross member intersects the back ends of the pair of longitudinal bones in the vehicle front-back direction. Therefore, the load transmitted from the wheel house can be sequentially transmitted from the longitudinal wall to the longitudinal bone, and then to the floor cross member, so as to effectively distribute the load everywhere, thereby improving the rigidity of the back floor bottom panel. Accordingly, the vehicle bottom structure of the disclosure has better rigidity to suppress torsion of the floor bottom panel and improve operability.

Finally, it should be noted that the above embodiments are merely used to illustrate the technical solution of the disclosure, but not to limit the disclosure. Although the disclosure has been described in detail with reference to the embodiments, it should be understood that persons of ordinary skill in the art can still modify the technical solutions recorded in the embodiments or make equivalent substitutions for some or all of the technical features. However, the modifications or substitutions do not cause the essence of the corresponding technical solution to depart from the scope of the technical solution of the embodiments of the disclosure.

What is claimed is:

1. A vehicle bottom structure, comprising:
a back floor bottom panel, comprising a protrusion portion; and
a pair of wheel houses, disposed on an outer side of the back floor bottom panel in a vehicle width direction, wherein
the protrusion portion is disposed on a central side between the pair of wheel houses in the vehicle width direction and protrudes upward in a vehicle up-down direction,
the protrusion portion comprises a longitudinal wall, and the longitudinal wall is formed at a front end of the protrusion portion in a vehicle front-back direction,
the longitudinal wall and the pair of wheel houses are disposed in parallel in the vehicle width direction.

2. The vehicle bottom structure according to claim 1, wherein the back floor bottom panel further comprises:
side frames, disposed on an outer side in the vehicle width direction, and extending along the vehicle front-back direction; and
a pair of longitudinal bones, extending along the vehicle front-back direction, and away from the side frames in the vehicle width direction, wherein
from a viewing angle in the vehicle up-down direction, part of the pair of longitudinal bones overlap the longitudinal wall.

3. The vehicle bottom structure according to claim 2, wherein
the back floor bottom panel also comprises a floor cross member, and the floor cross member is connected to the pair of wheel houses,
the longitudinal wall is disposed further forward than the floor cross member in the vehicle front-back direction, and the floor cross member intersects the pair of longitudinal bones.

4. The vehicle bottom structure according to claim 3, wherein
the protrusion portion further comprises an upper wall, the upper wall extends from an upper end of the longitudinal wall in the vehicle up-down direction toward a back in the vehicle front-back direction, and the upper wall intersects the floor cross member.

5. The vehicle bottom structure according to claim 3, wherein
the pair of longitudinal bones are disposed on a lower surface of the back floor bottom panel,
from a viewing angle in the vehicle front-back direction, a cross section of each of the pair of longitudinal bones is formed into a hat shape with an opening facing upward in the vehicle up-down direction,
the back floor bottom panel further comprises a patch component, from the viewing angle in the vehicle up-down direction, the patch component overlaps the longitudinal wall, and the patch component is connected to the pair of longitudinal bones.

6. The vehicle bottom structure according to claim 5, wherein
the patch component comprises an extension portion, and the extension portion extends toward a back in the vehicle front-back direction and intersects the floor cross member.

7. The vehicle bottom structure according to claim 6, wherein
the floor cross member comprises a reinforcement member, and the reinforcement member extends toward the back in the vehicle front-back direction and is joined to the back floor bottom panel,
the reinforcement member is disposed on an upper surface of the back floor bottom panel, and from the viewing angle in the vehicle up-down direction, the reinforcement member overlaps the extension portion of the patch component.

8. The vehicle bottom structure according to claim 2, wherein
the back floor bottom panel is disposed with a driving source below in the vehicle up-down direction,
from the viewing angle in the vehicle up-down direction, the pair of longitudinal bones overlap the driving source.

9. The vehicle bottom structure according to claim 1, further comprising:
a step portion, disposed in front of the longitudinal wall in the vehicle front-back direction, and connecting the front floor bottom panel and the back floor bottom panel,
an intermediate step portion, disposed between the step portion and the longitudinal wall.

10. The vehicle bottom structure according to claim 1, wherein
the pair of wheel houses comprise shock-absorbing support portions, and the shock-absorbing support portions are disposed at upper ends of the pair of wheel houses in the vehicle up-down direction,
the longitudinal wall is disposed further forward than the shock-absorbing support portions in the vehicle front-back direction.
